(19) United States
(12) Patent Application Publication
(10) Pub. No.: US 2026/0003319 A1
(43) Pub. Date: Jan. 1, 2026

(54) IMAGE FORMING APPARATUS

(71) Applicant: CANON KABUSHIKI KAISHA, Tokyo (JP)

(72) Inventors: YASUAKI MATSUMOTO, Kanagawa (JP); MASAKI IWASE, Shizuoka (JP)

(21) Appl. No.: 19/247,535

(22) Filed: Jun. 24, 2025

(30) Foreign Application Priority Data
Jun. 27, 2024 (JP) 2024-104492

(51) Int. Cl. G03G 21/16; G03G 15/08; G03G 21/20

(52) U.S. Cl. CPC G03G 21/1647; G03G 15/0881; G03G 21/206; G03G 2221/163; G03G 2221/1645; G03G 2221/1648; G03G 2221/1657

(57) ABSTRACT

A developer container detachably attached at a predetermined mounting position includes: a developer accommodating chamber, a filter that allows passage of air and suppresses passage of the developer, and an air chamber that is partitioned from the developer accommodating chamber by the filter, and switching between a first state and a second state can be made, the first state being a state in which a driving force of a motor is transmitted to an air supply portion that supplies the air to the air chamber, and is not transmitted to a movement mechanism that moves a restricting member between a restricting position for restricting movement of the developer container and an allowing position for allowing the movement of the developer container, and the second state being a state in which the driving force is transmitted to the movement mechanism and is not transmitted to the air supply portion.

### BACKGROUND

### Field of the Technology

The present disclosure relates to an image forming apparatus that replenishes a developer from a developer replenishing container detachably attached to the image forming apparatus.

### Description of the Related Art

In an image forming apparatus such as a printer or a copying machine, developer such as a fine powder toner is used, and the toner is replenished from a toner replenishing container (developer replenishing container) to a developing portion each time the toner consumed for image formation runs out. Such a toner replenishing container includes, for example, a toner supply device that supplies air to the toner replenishing container by an air pump, sucks the toner in the toner replenishing container by a suction pump, and sends the toner to the developing portion of the image forming apparatus (for example, Japanese Patent Application Laid-open No. 2020-73984). Here, the toner replenishing container is positionally restricted so as not to come off during toner supply after being mounted on an apparatus main body of the image forming apparatus, and the restriction is released when the toner replenishing container is taken out from the body. Therefore, for such a configuration, a position restriction mechanism for positionally restricting the toner replenishing container is provided on the apparatus main body. Such a position restriction mechanism includes a position restriction mechanism that is coupled to a drive source provided in the apparatus main body and is operated by a driving force transmitted from the drive source. When the toner replenishing container is mounted on the apparatus main body, the position restriction mechanism moves to a restricting position by the driving force transmitted from the driving source, and when the toner replenishing container is taken out from the apparatus main body, the position restriction mechanism moves from the restricting position to a releasing position by the driving force (for example, Japanese Patent Laid-open No. 2023-62746).

However, in the above-described related art, different drive sources are used for driving the air pump and driving the position restriction mechanism of the toner replenishing container. Therefore, a large space is required in the apparatus main body to dispose each drive unit, which may lead to an increase in size of the apparatus main body. In addition, since the drive unit includes a plurality of drive sources, the number of components also increases, and there is a concern that an increase in the number of units leads to an increase in cost.

### SUMMARY

The present disclosure is directed to provide a technology to downsize a main body and reduce the number of components while providing both drive of an air pump and a position restriction mechanism of a toner replenishing container operated by the drive in an image forming apparatus that conveys a toner in the toner replenishing container to an image forming section by air.

The present disclosure is directed to provide a technology capable of achieving downsizing and cost reduction of an image forming apparatus in which a developer is replenished from a developer container detachably attached to an apparatus main body.

In order to solve the above problems, an image forming apparatus that forms an image on a recording material according to the present disclosure includes:
an apparatus main body that includes a body accommodating portion that accommodates developer, and a mounting portion; and
a developer container that is mounted by being moved in a mounting direction relative to the mounting portion of the apparatus main body, and is detached by being moved in a detachment direction opposite to the mounting direction, wherein
the developer container includes:
   a developer accommodating chamber that accommodates the developer and is provided with a discharge port;
   a filter that allows passage of air and suppresses passage of the developer;
   an air chamber that is partitioned from the developer accommodating chamber by the filter and is provided with an air receiving port for receiving the air; and
   an engaged portion, and
the apparatus main body includes:
   a developer conveyance passage that is configured to communicate with an inside of the body accommodating portion and is provided with a developer receiving port, the developer conveyance passage allowing communication between the developer accommodating chamber of the developer container and the inside of the body accommodating portion by connecting the developer receiving port to the discharge port of the developer container mounted at a predetermined position in the mounting portion;
   an air supply passage that is provided with an air feeding port, the air supply passage being configured to communicate with the air chamber of the developer container by connecting the air feeding port to the air receiving port of the developer container mounted at the predetermined position in the mounting portion;
   an air supply portion that supplies the air from the air receiving port of the developer container to the air chamber via the air supply passage;
   a restricting member having an engagement portion, the restricting member being movable between a restricting position and an allowing position, the restricting position being a position where the engagement portion is engaged with the engaged portion of the developer container so as to restrict the developer container from moving in the detachment direction from the predetermined position in the mounting portion, and the allowing position being a position where the engagement portion is not engaged with the engaged portion so as to allow the developer container to move in the detachment direction from the predetermined position;
   a movement mechanism that moves the restricting member between the restricting position and the allowing position;
   a drive transmission mechanism that includes a motor and a drive transmission portion, the drive transmission portion being configured to switch between a first state and a second state, the first state being a state in which a driving force of the motor is transmitted to the air supply portion and is not transmitted to the movement mechanism, and the second state being a state in which the driving force of the motor is transmitted to the movement mechanism and is not transmitted to the air supply portion; and
   a control portion that controls the drive transmission mechanism.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view for describing an image forming apparatus according to a first embodiment of the present disclosure.

FIG. 2 is a perspective view for describing cartridge replacement of the image forming apparatus according to the first embodiment of the present disclosure.

FIG. 3A is a cross-sectional view for describing an air conveyance configuration for a toner and release of position restriction of a toner container of the image forming apparatus in a state in which the toner container is stored at a predetermined mounting position of the accommodating portion (mounting portion) of the apparatus main body of the image forming apparatus according to the first embodiment of the present disclosure.

FIG. 3B is a cross-sectional view for describing an air conveyance configuration for a toner and release of position restriction of a toner container of the image forming apparatus in a state of a process of taking out the toner container from the apparatus main body according to the first embodiment of the present disclosure.

FIG. 3C is a cross-sectional view for describing an air conveyance configuration for a toner and release of position restriction of a toner container of the image forming apparatus in a state of a process of taking out the toner container from the apparatus main body according to the first embodiment of the present disclosure.

FIG. 4A is a cross-sectional view for illustrating a relationship between an operation of the locking claw and the movement of the toner container 1 of the image forming apparatus when the locking claw comes into contact with the cam coupled to the locking drive unit according to the first embodiment of the present disclosure.

FIG. 4B is a cross-sectional view for illustrating a relationship between an operation of the locking claw and the movement of the toner container of the image forming apparatus when replacing (removing) the toner container according to the first embodiment of the present disclosure.

FIG. 4C is a cross-sectional view for illustrating a relationship between an operation of the locking claw and the movement of the toner container of the image forming apparatus when inserting (attaching) the toner container according to the first embodiment of the present disclosure.

FIG. 5A is a detailed view illustrating details of an air supply portion and a toner discharge portion of the image forming apparatus according to the first embodiment of the present disclosure.

FIG. 5B is a detailed view illustrating details of an air supply portion and a toner discharge portion of the image forming apparatus when the toner container moves in a taking-out direction from the apparatus main body according to the first embodiment of the present disclosure.

FIG. 6 is a block diagram illustrating control according to the first embodiment of the present disclosure.

FIG. 7 is a flowchart illustrating control according to the first embodiment of the present disclosure.

FIG. 8 is a flowchart illustrating control according to the first embodiment of the present disclosure.

FIG. 9A is a cross-sectional view for describing an air conveyance configuration for a toner and release of position restriction of a toner container of an image forming apparatus in a state in which the toner container is stored in an accommodating portion (mounting portion) of the apparatus main body according to a second embodiment of the present disclosure.

FIG. 9B is a cross-sectional view for describing an air conveyance configuration for a toner and release of position restriction of a toner container of an image forming apparatus in a process of taking out the toner container from the apparatus main body according to a second embodiment of the present disclosure.

FIG. 9C is a cross-sectional view for describing an air conveyance configuration for a toner and release of position restriction of a toner container of an image forming apparatus in a process of taking out the toner container from the apparatus main body according to a second embodiment of the present disclosure.

FIG. 10A is a cross-sectional view for illustrating a relationship between the operation of the locking lever and the movement of the toner container of the image forming apparatus according to the second embodiment of the present disclosure.

FIG. 10B is a cross-sectional view for illustrating a relationship between the operation of the locking lever and the movement of the toner container of the image forming apparatus when replacing the toner container according to the second embodiment of the present disclosure.

FIG. 10C is a cross-sectional view for illustrating a relationship between the operation of the locking lever and the movement of the toner container of the image forming apparatus at the time of insertion of the toner container according to the second embodiment of the present disclosure.

FIG. 11A is a cross-sectional view for describing an air conveyance configuration for a toner and release of position restriction of a toner container of an image forming apparatus in a state in which the toner container is stored in an accommodating portion (mounting portion) of the apparatus main body according to a third embodiment of the present disclosure.

FIG. 11B is a cross-sectional view for describing an air conveyance configuration for a toner and release of position restriction of a toner container of an image forming apparatus in a process of taking out the toner container from the apparatus main body according to a third embodiment of the present disclosure.

FIG. 11C is a cross-sectional view for describing an air conveyance configuration for a toner and release of position restriction of a toner container of an image forming apparatus in a process of taking out the toner container from the apparatus main body according to a third embodiment of the present disclosure.

FIG. 12 is a block diagram illustrating control according to the third embodiment of the present disclosure.

FIG. 13 is a flowchart illustrating control according to the third embodiment of the present disclosure.

FIG. 14A is a cross-sectional view for describing an air conveyance configuration for a toner and release of position restriction of a toner container of an image forming apparatus in a state in which the toner container is stored in an accommodating portion (mounting portion) of the apparatus main body according to a fourth embodiment of the present disclosure.

FIG. 14B is a cross-sectional view for describing an air conveyance configuration for a toner and release of position restriction of a toner container of an image forming apparatus in a process of taking out the toner container from the apparatus main body according to a fourth embodiment of the present disclosure.

FIG. 14C is a cross-sectional view for describing an air conveyance configuration for a toner and release of position restriction of a toner container of an image forming apparatus in a process of taking out the toner container from the apparatus main body according to a fourth embodiment of the present disclosure.

FIG. 15A is a schematic explanatory view of drive coupling between a locking claw and a locking drive unit in a state in which the locking claw is at the restricting position.

FIG. 15B is a schematic explanatory view of drive coupling between a locking claw and a locking drive unit in a process in which the locking claw moves from the restricting position to the retracted position by the driving force transmitted from the locking drive unit.

FIG. 15C is a schematic explanatory view of drive coupling between a locking claw and a locking drive unit in a process in which the locking claw moves from the restricting position to the retracted position by a force received from the toner container inserted into the mounting portion of the apparatus main body.

FIG. 16A is a schematic explanatory view of drive coupling between a locking lever and the locking drive unit in a state in which the locking lever is at the restricting position.

FIG. 16B is a schematic explanatory view of drive coupling between a locking lever and the locking drive unit in a process in which the locking lever is changed (rotates) from the restricting posture to the retracted posture by the driving force transmitted from the locking drive unit.

FIG. 16C is a schematic explanatory view of drive coupling between a locking lever and the locking drive unit in a process in which the locking lever is changed from the retracted posture to the restricting posture by a force received from the toner container inserted into the mounting portion of the apparatus main body.

FIG. 17A is a schematic explanatory view of a configuration of a valve and drive coupling between the valve and a motor in a state in which a valve body of the valve is seated on a valve seat and the valve is closed.

FIG. 17B is a schematic explanatory view of a configuration of a valve and drive coupling between the valve and a motor in a state in which the valve body is separated from the valve seat in the valve and the valve is changed from a closed state to an open state.

FIG. 17C is a schematic explanatory view of a configuration of a valve and drive coupling between the valve and a motor in a state in which the valve is further opened in the state illustrated in FIG. 17B.

### DESCRIPTION OF THE EMBODIMENTS

Modes for implementing the present disclose will now be exemplarily described in detail based on examples with reference to the drawings. However, it is to be understood that dimensions, materials, shapes, relative arrangements, and the like of components described in the embodiments are intended to be changed as deemed appropriate in accordance with configurations and various conditions of apparatuses to which the disclosure is to be applied. In other words, the scope of the present disclose is not intended to be limited to the embodiments described below. While a plurality of features are described in each of the embodiments, all of the plurality of features are not necessarily essential to the disclosure and the plurality of features may be combined with each other in any way. Moreover, in the accompanying drawings, the same reference numeral will be assigned to the same or similar components and overlapping descriptions will be omitted.

### First Embodiment

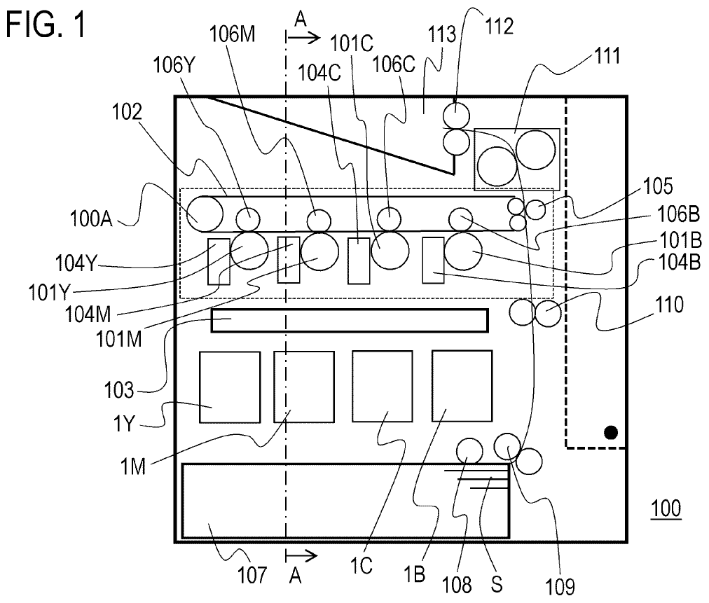

FIG. 1 is a schematic cross-sectional view schematically for describing a configuration of a color laser printer which is an example of an image forming apparatus according to a first embodiment of the present disclosure. The image forming apparatus includes an image forming apparatus main body (hereinafter, referred to as an apparatus main body) 100, and an image forming portion 100A that is provided in the apparatus main body 100 and performs image formation by an electrophotographic system. The image forming portion 100A includes photosensitive drums (image bearing members) 101, an intermediate transfer belt 102, developing apparatuses 104, primary transfer rollers 106, and a secondary transfer roller 105.

The photosensitive drums 101 include four photosensitive drums (image bearing members) 101Y, 101M, 101C, and 101K that form toner images (developer images) of four colors of yellow, magenta, cyan, and black. The intermediate transfer belt 102 is an endless belt-shaped member which comes into contact with the four photosensitive drums 101Y to 101K and to which the toner images formed on the four photosensitive drums 101Y to 101K are primarily transferred. The primary transfer rollers 106 include primary transfer rollers 106Y, 106M, 106C, and 106K corresponding to the toners of four colors. The primary transfer rollers 106Y to 106K are disposed at positions corresponding to the photosensitive drums 101Y to 101K on an inner peripheral side of the intermediate transfer belt 102. The primary transfer rollers 106Y to 106K sandwich the intermediate transfer belt 102 with the photosensitive drums 101Y to 101K such that nips are formed between the photosensitive drums 101Y to 101K and an outer peripheral side of the intermediate transfer belt 102. When a primary transfer bias is applied from a power supply (not illustrated), the primary transfer rollers 106Y to 106K generate potential differences between the photosensitive drums 101Y, 101M, 101C, and 101K and the intermediate transfer belt 102, and the toner images borne on the photosensitive drums 101Y to 101K at the above-described nips are sequentially primarily transferred to the outer peripheral side of the intermediate transfer belt 102 in a superimposed manner. The secondary transfer roller 105 forms a nip with the outer peripheral side of the intermediate transfer belt 102, and secondarily transfers the images transferred from the photosensitive drums 101Y to 101K to the intermediate transfer belt 102 to a sheet (recording material) S when a secondary transfer bias is applied from the power supply (not illustrated).

When an image forming operation is started in the image forming section 100A, the photosensitive drums 101Y to 101K are irradiated with light corresponding to an image signal by a laser scanner 103, and latent images are formed on the photosensitive drums 101Y to 101K. Each of developing apparatuses 104Y, 104M, 104C, and 104K includes a developing roller (developer bearing member), a developing blade (developer restricting member), a toner accommodating portion (developer accommodating portion or body accommodating portion), and the like. In FIG. 1, only the toner accommodating portions of the configurations of the developing apparatuses 104Y to 104K are illustrated. The developing apparatuses 104Y to 104K develop the latent images on the photosensitive drums 101Y to 101K by using the toners stored in the toner accommodating portions, and form the toner images (visible images) on the photosensitive drums 101Y to 101K. The toner images formed on the photosensitive drums 101Y to 101K are then primarily transferred to the intermediate transfer belt 102.

The toner images borne on the intermediate transfer belt 102 are conveyed to a secondary transfer portion by the rotation of the intermediate transfer belt 102. In the developing apparatuses 104Y to 104K, when the toner accommodated in the toner accommodating portion is consumed, the toners are sequentially pumped up from toner cartridges 1Y, 1M, 1C, and 1K serving as developer containers and replenished.

In parallel with the image forming operation, a plurality of sheets S accommodated in the sheet storage portion 107 are fed one by one by a pickup roller 108. Then, the sheet S is conveyed to the secondary transfer portion formed by the nip between the intermediate transfer belt 102 and the secondary transfer roller 105, by a feed roller 109 and a registration roller 110 that performs skew feeding correction of the sheet S. Here, since it is necessary to align a position of the sheet S in a sheet conveyance direction with respect to the toner images formed on the intermediate transfer belt 102, a timing for conveying the sheet S to the secondary transfer portion is adjusted by conveyance speed control of the registration roller 110 and the feed roller 109. In the secondary transfer portion, the toner images are transferred from the intermediate transfer belt 102 to the sheet S by applying a high-voltage current to the secondary transfer roller 105. Thereafter, the sheet S to which the toner images have been transferred is conveyed to a fixing unit 111, and the toner images are fixed to the sheet S by being heated and pressurized in the fixing unit 111. After the fixing, the sheet S is discharged to a discharge portion 113 at an upper portion of the apparatus by a discharge roller 112.

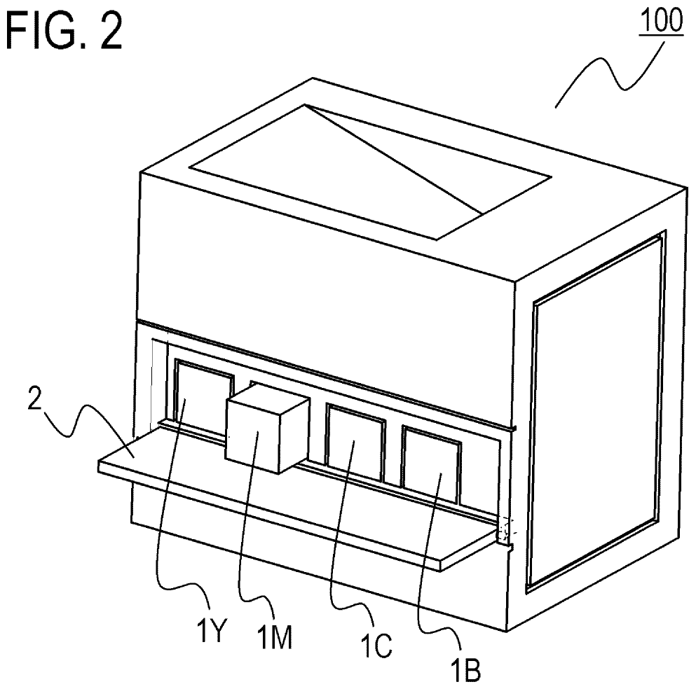

FIG. 2 is a view illustrating a state in which a toner container replacement door 2 is opened to replace a toner cartridge (hereinafter, referred to as a toner container) 1 detachably attached to the apparatus main body 100. Four toner containers 1 are arranged in the order of a toner container 1Y for accommodating a yellow toner, a toner container 1M for accommodating a magenta toner, a toner container 1C for accommodating a cyan toner, and a toner container 1B for accommodating a black toner. Each of the toner containers 1Y to 1K is mounted on an accommodating portion in the apparatus main body 100. FIG. 2 illustrates a state in which the toner container 1M is replaced as an example, and the toner container 1M is replaced by being pulled out from an apparatus back surface side toward an apparatus front surface side through an opening provided in a front surface of the apparatus main body 100 of the image forming apparatus.

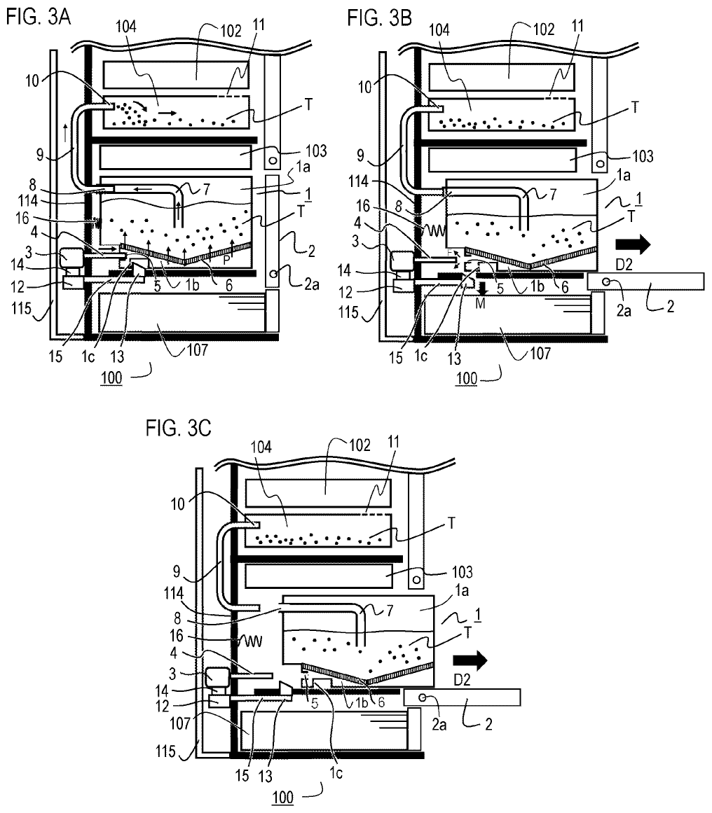

FIGS. 3A, 3B, and 3C are cross-sectional views of the apparatus main body 100 in FIG. 1 when viewed in a direction of arrow A. FIG. 3A is a view for describing a situation in which a toner T is conveyed from the toner container 1 to the toner accommodating portion of the developing apparatus 104 by air in a state in which the toner container 1M is stored at a predetermined mounting position of the accommodating portion (mounting portion) of the apparatus main body 100 of the image forming apparatus. FIGS. 3B and 3C are views for describing a state of a process of taking out the toner container 1 from the apparatus main body 100.

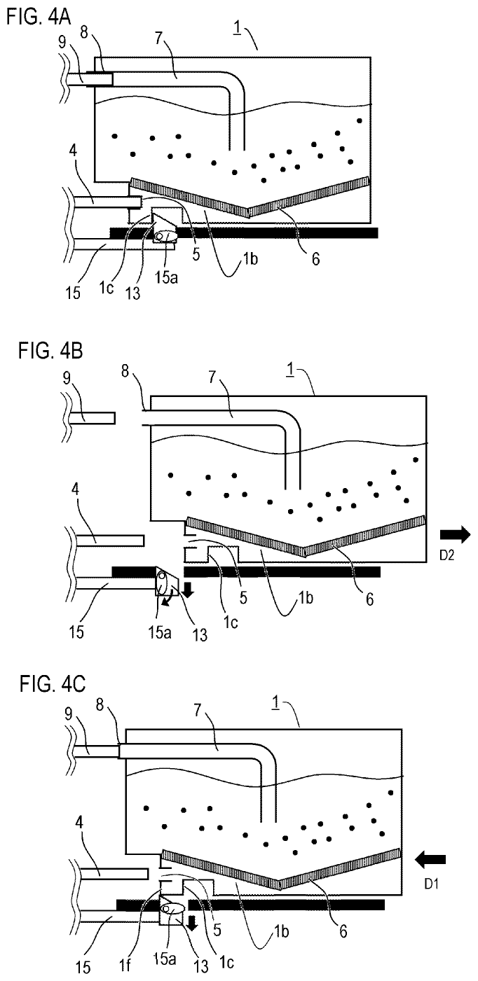

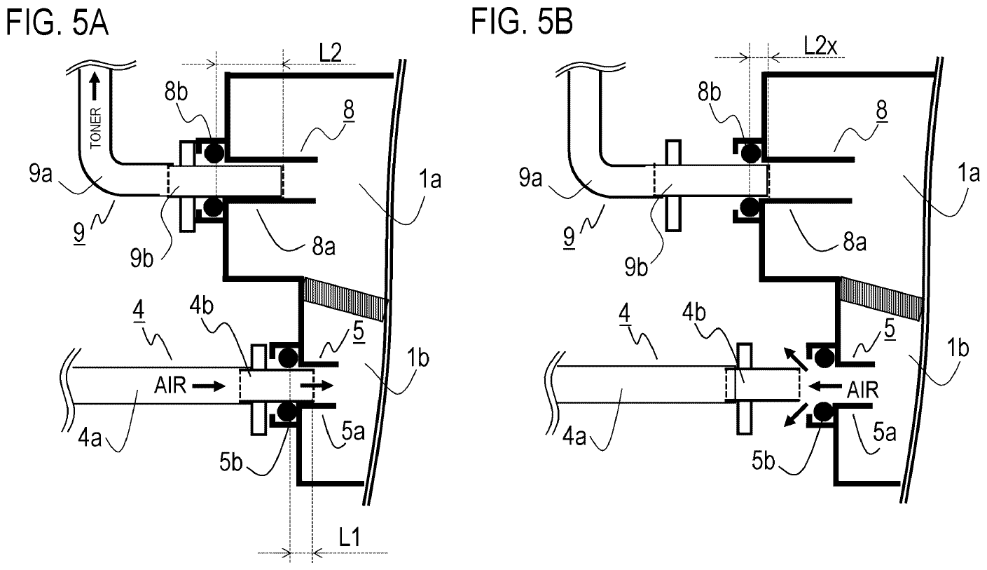

FIGS. 3A, 3B, and 3C illustrate only the toner accommodating portion in a configuration of the developing apparatus 104 as in FIG. 1. Further, the developing apparatus 104 and the toner container 1 illustrated in FIGS. 3A to 3C are the developing apparatus 104M and the toner container 1M for the magenta toner, but the developing apparatuses 104Y, 104C, and 104B and the toner containers 1Y, 1C, and 1B for the toners of other colors are similarly configured. In the configuration illustrated in FIGS. 3A to 3C and a description related to FIGS. 3A to 3C, Y, M, C, and B added to the end of each reference numeral in order to distinguish the color of the toner are appropriately omitted unless color distinction is required. The same applies to FIGS. 4A to 4C and FIGS. 5A and 5B. That is, Y, M, C, and B are also omitted for each configuration of the developing apparatus 104, a pump 3, an air conveyance passage 4, a toner discharge passage 7, and the like provided for each toner container 1 described below.

The pump 3 illustrated in FIG. 3A is an air pump that supplies air to the toner container 1 from an air supply portion 5 of the toner container 1 through the air conveyance passage 4. The pump 3 is disposed outside a frame body 114 of the apparatus main body 100 that forms a space (mounting portion) for accommodating the toner container 1, and is configured be able to be replaced by being accessed from the apparatus back surface side after taking out an exterior 115 when replacement due to a failure is required. Similarly to the pump 3, a motor 12 is disposed outside the frame body 114, and is drivingly coupled to the pump 3 via a pump drive unit 14. A filter bed 6 provided in the toner container 1 is a filter for separating (partitioning) between a toner accommodating chamber (developer accommodating chamber) 1a and an air chamber 1b in the toner container 1. The filter bed 6 is a filter whose fineness is sufficiently smaller than a toner T particle size, which obstructs (suppresses) passage of the toner T and allows only the air to pass therethrough.

FIG. 5A is a detailed view illustrating details of connection of the air supply portion 5 and connection of the toner discharge portion 8. The air conveyance passage 4 includes an air conveyance tube 4a and an air supply connection port 4b. The air conveyance passage 4 is an air supply passage that can communicate with the inside of the toner container 1 by being connected to the air supply portion 5. The air supply connection port (air feeding port) 4b is opened in a direction (second direction) (a direction of arrow D2) opposite to a mounting direction (first direction) (a direction of arrow D1 of FIG. 4C) of the toner container 1 with respect to the mounting portion of the apparatus main body 100. The air conveyance tube 4a is a tube that feeds the air from the pump 3 to the toner container 1. The air supply portion 5 includes an air feeding port 5a and an O-ring 5b. The air feeding port (air receiving port) 5a is a connection portion to which the air supply connection port (air feeding port) 4b is connected, and is opened in the mounting direction (first direction) (the direction of arrow D1) of the toner container 1 with respect to the mounting portion of the apparatus main body 100. The O-ring 5b is an annular sealing member that is in close contact with an outer periphery of the air supply connection port 4b to prevent the air from leaking to the outside of the toner container 1. In a state in which the toner container 1 is mounted in the apparatus main body 100, a tip of the air supply connection port 4b is inserted into the air chamber 1b by a connection distance L1 from a position (for example, a wire diameter center of the O-ring 5b) of the O-ring 5b in an insertion direction with respect to the air feeding port 5a.

A toner conveyance passage 9 includes a toner conveyance tube 9a and a toner conveyance connection port 9b. The toner conveyance passage 9 is a developer conveyance passage that communicates with the inside of the toner accommodating portion of the developing apparatus 104 and enables communication between the inside of the toner container 1 and the inside of the toner accommodating portion of the developing apparatus 104 by being connected to the toner discharge portion 8. The toner conveyance connection port (developer receiving port) 9b is opened in the direction (second direction) (the direction of arrow D2) opposite to the mounting direction (first direction) (the direction of arrow D1 in FIG. 4C) of the toner container 1 with respect to the mounting portion of the apparatus main body 100. The toner conveyance tube 9a is a tube that guides the toner fed by an air pressure. The toner conveyance tube 9a is disposed in a passage that avoids an interference with other units in the apparatus main body 100 such as the laser scanner 103 interposed between the toner container 1 and the toner accommodating portion of the developing apparatus 104 and functional portions such as a laser optical path. The toner discharge portion 8 includes a toner conveyance port 8a and an O-ring 8b. The toner conveyance port (developer discharge port) 8a is a connection portion to which the toner conveyance connection port 9b is connected, and is opened in the mounting direction (first direction) (the direction of arrow D1) of the toner container 1 with respect to the mounting portion of the apparatus main body 100. The O-ring 8b is an annular sealing member that is in close contact with an outer periphery of the toner conveyance connection port 9b to prevent the toner from leaking to the outside of the toner container 1. In a state in which the toner container 1 is mounted in the apparatus main body 100, a tip of the toner conveyance connection port 9b is inserted into the toner accommodating chamber 1a by a connection distance L2 from a position of the O-ring 8b (for example, a wire diameter center of the O-ring 8b) in an insertion direction with respect to the toner conveyance port 8a.

By sealing outer peripheral portions of the air supply connection port 4b and the toner conveyance connection port 9b with the O-ring 5b and the O-ring 8b in this manner, reliable sealing can be performed even in a case where positioning of the toner container 1 in attachment and detachment directions with respect to the apparatus main body 100 is not precise. Here, a relationship between connection distances, which are insertion amounts in the connection of the air supply portion 5 and the toner discharge portion 8, is set such that “L1<L2” as illustrated in FIG. 5A. That is, when the toner container 1 is moved in a detachment direction (the direction of arrow D2) from a predetermined mounting position in the mounting portion, a timing (first timing) at which the O-ring 8b serving as a first sealing member no longer remains in close contact with the outer periphery of the toner conveyance connection port 9b is later than a timing (second timing) at which the O-ring 5b serving as a second sealing member no longer remains in close contact with the outer periphery of the air supply connection port 4b.

Next, a toner replenishing operation of the image forming apparatus will be described. When the motor 12 rotates in a certain direction (first rotation direction), the pump drive unit 14 is driven to transmit drive to the pump 3. The pump drive unit 14 is a first drive transmission portion that transmits a driving force generated by the motor 12 to the pump 3 serving as an air supply portion to drive the pump 3, and includes a drive train including a one-way gear described below. When the pump 3 is driven, the air is supplied to the toner container 1 through the air supply portion 5 in a direction of an arrow. When the air is supplied to the toner container 1, an internal pressure of the entire toner container 1 including the toner accommodating chamber 1a is increased by the air passing through the filter bed 6 from the air chamber 1b. The toner T in the toner accommodating chamber 1a is conveyed from the toner discharge portion 8 to the outside of the toner container 1 through the toner discharge passage 7 by an increased air pressure P. The toner T discharged from the toner discharge portion 8 is conveyed to the toner accommodating portion of the developing apparatus 104 with a flow of the air through the toner conveyance passage 9 provided in the apparatus main body 100. In the present embodiment, the motor 12 and the pump 3 are coupled as a set for each color, but a configuration in which the number of motors 12 is one, and a clutch that is coupled to the motor 12 and is capable of connecting and disconnecting drive transmission is connected to each of the pumps 3 of the colors may be adopted. The toner T conveyed through the toner conveyance passage 9 is supplied to the toner accommodating portion of the developing apparatus 104 from a back side of the developing apparatus 104 in the attachment/detachment directions, and is fed by the air pressure in a longitudinal direction of the toner accommodating portion. A degassing portion 11 is a filter provided on a top surface or near the top surface of the toner accommodating portion of the developing apparatus 104 to remove the air in the toner accommodating portion, and has air permeability necessary for appropriately conveying the toner T in the toner accommodating portion.

Referring to FIG. 3A, position restriction of the toner container 1 will be described. A pressing member 16 is provided in the apparatus main body 100 of the image forming apparatus in order to assist in taking out the toner container 1. The pressing member 16 is configured to press (apply an urging force to) the toner container 1 so as to move the toner container 1 from the predetermined mounting position (mounting completion position) in the mounting portion of the apparatus main body 100 to a taking-out position where at least a part of the toner container 1 protrudes to the outside of the apparatus main body 100.

Further, a locking claw 13 is provided in the apparatus main body 100 such that the toner container 1 does not protrude when being pressed by the pressing member 16 after being mounted on the apparatus main body 100. A locking receiving surface 1c with which the locking claw 13 can come into contact is provided in the toner container 1. The locking claw 13 of the apparatus main body 100 is positioned at a position facing the locking receiving surface 1c of the toner container 1 in the attachment/detachment directions of the toner container 1 with respect to the apparatus main body and comes into contact with the locking receiving surface 1c, whereby the movement of the toner container 1 in the attachment/detachment directions with respect to the apparatus main body 100 is restricted. As a result, the toner container 1 is prevented from unintentionally coming off from the apparatus main body 100. The locking claw 13 is movably attached to the locking drive unit 15, and the locking drive unit 15 is drivingly coupled to the motor 12. The locking drive unit 15 is a second drive transmission portion that transmits a driving force generated by the motor 12 to the locking claw 13 serving as a restricting member to drive the locking claw 13, and includes a drive train including a one-way gear described below. The locking claw 13 is disposed on a side close to the motor 12 to shorten a drive coupling distance to the motor 12.

FIG. 3B is a view for describing a process of taking out the toner container 1 from the apparatus main body 100 of the image forming apparatus for replacement or the like. The toner container replacement door 2 is an opening/closing door (opening/closing member) that is held so as to be rotatable around a door hinge 2a. When the toner container replacement door 2 is opened, an opening of a toner container accommodating portion in the apparatus main body 100 is opened to the outside of the apparatus main body 100, so that the toner container 1 can be replaced.

The toner container 1 has, on an outer bottom surface (lower surface) of a bottom portion, as a restricted portion, a recessed portion that is recessed in a direction (vertical direction) intersecting the attachment/detachment directions of the toner container 1 with respect to the apparatus main body 100. The recessed portion has the locking receiving surface 1c serving as an engaged portion. The locking receiving surface 1c is a surface facing a detachment direction (second direction) opposite to an attachment direction (first direction) of the toner container 1 with respect to the apparatus main body 100. The locking claw 13 serving as the restricting member faces the locking receiving surface 1c so as to be able to come into contact with the locking receiving surface 1c in a restricting posture (restricting position). The locking claw 13 is provided in the apparatus main body 100 so as to be movable in the vertical direction intersecting (orthogonal to) the attachment/detachment directions. The locking claw 13 moves in the above direction by an action of the locking drive unit 15 that has received a rotational driving force of the motor 12. With such movement, the locking claw 13 can be changed from the restricting posture (restricting position) to a retracted posture (non-restricting posture, non-restricting position, or retracted position) in which the locking claw 13 is pulled out of the recessed portion.

In a case where the toner container 1 needs to be replaced, the motor 12 rotates in a direction (an opposite direction and a second rotation direction) opposite to the direction (first rotation direction) in which the pump 3 is driven, and drives the locking drive unit 15. By the locking drive unit 15, the locking claw 13 moves in a direction of arrow M, that is, in a direction intersecting the attachment/detachment directions (D1 and D2) of the toner container 1 with respect to the apparatus main body 100, and is retracted from a position facing the locking receiving surface 1c of the toner container 1.

When the motor 12 drives the locking drive unit 15, the pump 3 is not driven and is stopped. This is because the one-way gear (not illustrated) is provided in the pump drive unit 14, and when the motor 12 rotates in a reverse direction, the one-way gear idles, and drive of the motor 12 is not transmitted to the pump 3. That is, the driving force of the motor 12 is transmitted to the pump 3 and is not transmitted to a cam 15a of the locking drive unit 15 serving as a movement mechanism (first state). Conversely, when the motor 12 rotates in a direction for driving the pump 3, the one-way gear (not illustrated) is also provided in the locking drive unit 15 similarly to the pump drive unit 14, and the locking claw 13 is not operated due to an action thereof. That is, the driving force of the motor 12 is transmitted to the cam 15a of the locking drive unit 15 serving as the movement mechanism and is not transmitted to the pump 3 (second state). A configuration that implements the switching of the drive transmission forms a drive transmission portion according to the present disclosure, and a drive transmission mechanism according to the present disclosure includes the drive transmission portion and the motor. The configuration of the drive transmission mechanism is not limited to the configuration in which the rotation direction of the motor 12 is switched as in the present embodiment. For example, an actuator such as a solenoid may be disposed downstream of the drive train of the motor 12, and the actuator may be controlled to switch between a first mode (first state) and a second mode (second state) having different drive transmission paths.

When the locking claw 13 is retracted, the position restriction in a protruding direction from the apparatus main body 100 is released, and the toner container 1 can be moved to the taking-out position by the pressing of the pressing member 16. The position restriction of the toner container 1 is released, and the toner container 1 is pushed out from the mounting portion of the apparatus main body 100 to a position where at least a part of the toner container 1 is exposed to the outside by the pressing of the pressing member 16. The toner container 1 moves in the direction of the arrow while being supported by an upper surface of the opened toner container replacement door 2, and can be taken out.

FIGS. 4A, 4B, and 4C are views illustrating a relationship between an operation of the locking claw 13 and the movement of the toner container 1. As illustrated in FIG. 4A, the locking claw 13 comes into contact with the cam 15a coupled to the locking drive unit 15.

When replacing (removing) the toner container 1, the cam 15a rotates in an arrow direction (clockwise in figure) to push down the locking claw 13 as illustrated in FIG. 4B. As a result, the locking claw 13 is retracted from the position facing the locking receiving surface 1c of the toner container 1, and the position restriction of the toner container 1 is released. The cam 15a that has rotated to a position restriction releasing position further rotates in the second direction, returns to a position restricting position, and is stopped.

When inserting (attaching) the toner container 1, the cam 15a is stopped at the position restricting position as illustrated in FIG. 4C. The locking claw 13 moves in a releasing direction (clockwise in the figure) by drive of the cam 15a and is movable downward in the figure regardless of the cam 15a. Therefore, when the toner container 1 is put again, the toner container 1 pushes down the locking claw 13. Thereafter, the toner container 1 moves over the locking claw 13 to the mounting position, and the locking claw 13 returns to the restricting position by an urging member (not illustrated) and comes into contact with the locking receiving surface 1c of the toner container 1 to perform the position restriction.

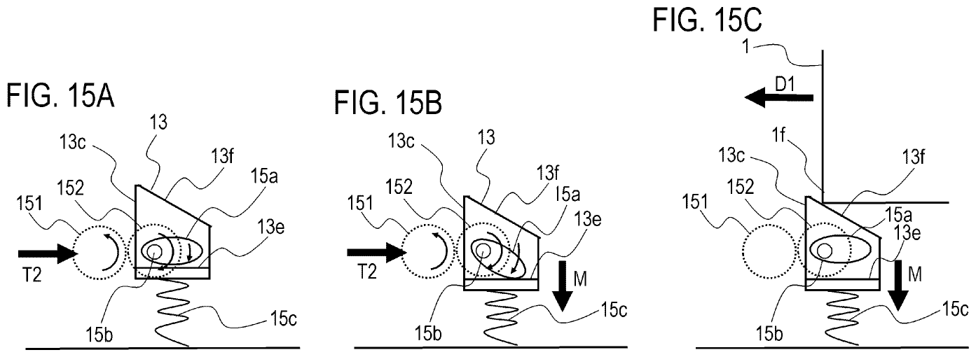

A drive coupling configuration of the locking claw 13 and the locking drive unit 15 will be described in more detail with reference to FIGS. 15A to 15C. FIG. 15A is a schematic explanatory view of the drive coupling configuration of the locking claw 13 and the locking drive unit 15, and illustrates a state in which the locking claw 13 is at the restricting position. The locking drive unit 15 includes, as a part of the drive train, a first gear 151 and a second gear 152 disposed downstream of the drive train of the first gear 151 and coupled to the cam 15a. A driving force T2 generated by the rotation of the motor 12 in the second rotation direction is sequentially transmitted in the drive train of the locking drive unit 15, and rotates the cam 15a around a rotation axis of a rotation shaft 15b via rotation of the first gear 151 and the second gear 152. The second gear 152 is a one-way gear, and is configured to idle with respect to the first gear 151 that rotates by a driving force generated by the rotation of the motor 12 in the first rotation direction.

FIG. 15B is a schematic explanatory view of the drive coupling configuration of the locking claw 13 and the locking drive unit 15, and illustrates a process in which the locking claw 13 moves from the restricting position to the retracted position by the driving force T2 transmitted from the locking drive unit 15. The locking claw 13 has an action receiving surface 13e that receives an acting force of the cam 15a. The action receiving surface 13e is a surface positioned below the cam 15a and facing upward, and is configured to receive a force in a direction (a downward direction in the vertical direction in the present embodiment) intersecting the mounting direction (the direction of arrow D1) of the toner container 1 from the rotating cam 15a. When the action receiving surface 13e receives such a force, the locking claw 13 moves downward (in the direction of arrow M). As a result, the locking claw 13 moves from the restricting position to the retracted position against an urging force of a spring 15c serving as the urging member (elastic member) that urges the locking claw 13 to be positioned at the restricting position.

FIG. 15C is a schematic explanatory view of the drive coupling configuration of the locking claw 13 and the locking drive unit 15, and illustrates a process in which the locking claw 13 moves from the restricting position to the retracted position by a force received from the toner container 1 inserted into the mounting portion of the apparatus main body 100 (moving in the direction of arrow D1). The locking claw 13 has an action receiving surface (action receiving portion) 13f which is an inclined surface inclined with respect to the mounting direction (the direction of arrow D1) of the toner container 1. The toner container 1 has an action surface (action portion) 1f at a distal end corner portion in the mounting direction, and has a configuration in which the action surface 1f comes into contact with the action receiving surface 13f of the locking claw 13 while the toner container 1 is mounted on the mounting portion of the apparatus main body 100. The action receiving surface 13f is inclined so as to generate a component force in a direction intersecting the mounting direction (downward in the vertical direction in the present embodiment) with respect to the force applied in the mounting direction (the direction of arrow D1) of the toner container 1 and received from the action surface 1f. Therefore, when the action receiving surface 13f receives a force for inserting the toner container 1 into the mounting portion via the action surface 1f, the locking claw 13 moves in a direction (the direction of arrow M) intersecting the mounting direction. At this time, the locking claw 13 can move independently of the locking drive unit 15, and the action receiving surface 13e is separated from the cam 15a.

As illustrated in FIG. 5A, the connection between the air conveyance passage 4 and the air supply portion 5 and the connection between the toner discharge portion 8 and the toner conveyance passage 9 have a relationship of L1<L2. Therefore, as illustrated in FIG. 5B, when the toner container 1 moves in a taking-out direction from the apparatus main body 100, first, the connection of the air supply portion 5 to the air conveyance passage 4 is released, and the connection of the toner discharge portion 8 to the toner conveyance passage 9 remains connected by a connection distance L2x. At this time, the air in the air chamber 1b goes out in a direction of an arrow, and the internal pressure in the toner container 1 becomes equal to an ambient atmospheric pressure. When the toner container 1 is further moved from the position illustrated in FIG. 3B, a state illustrated in FIG. 3C is obtained, and the connection of the toner discharge portion 8 to the toner conveyance passage 9 is also released.

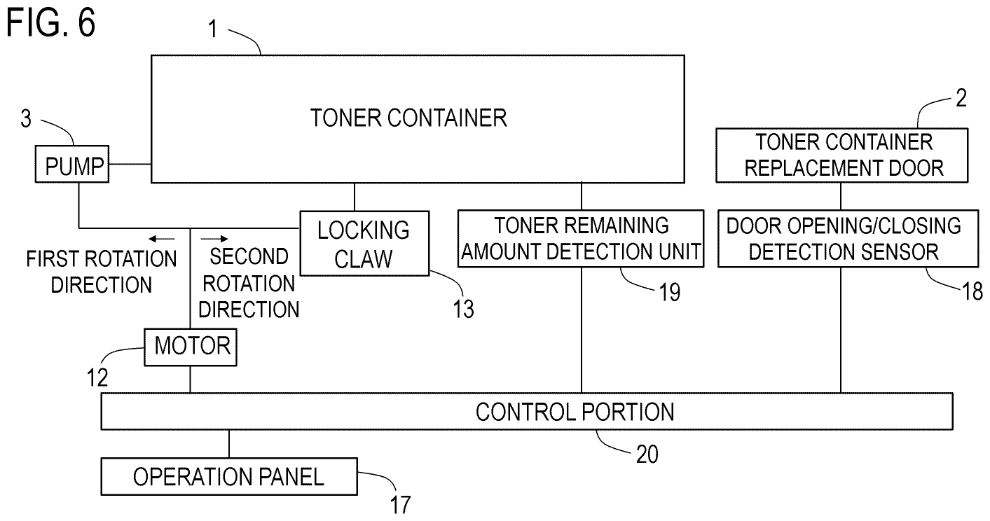

FIG. 6 is a block diagram illustrating a configuration of a control system of a toner supply portion according to the first embodiment. A toner remaining amount detection unit 19 illustrated in FIG. 6 is a sensor that detects a remaining amount of the toner T remaining in the toner container 1. Toner remaining amount information detected by the toner remaining amount detection unit 19 is sent to a control portion 20. A door opening/closing detection sensor 18 is a sensor that detects an opening/closing state of the toner container replacement door 2. A detection result of the door opening/closing detection sensor 18 is sent to the control portion 20. The motor 12 acts on the pump 3 and supplies the air to the toner container 1. The motor 12 rotates in the first rotation direction according to an instruction from the control portion 20 to drive the pump 3. The locking claw 13 is a locking member of the toner container 1 movable to the position restriction releasing position where the toner container 1 can be taken out from the apparatus main body 100 based on a command from the control portion 20. An operation panel 17 is an operation portion (input portion) that is used when a user operates the image forming apparatus and receives inputs of various operations from the user. For example, when taking out the toner container 1 from the image forming apparatus, the user can give an instruction to the image forming apparatus via the operation panel 17.

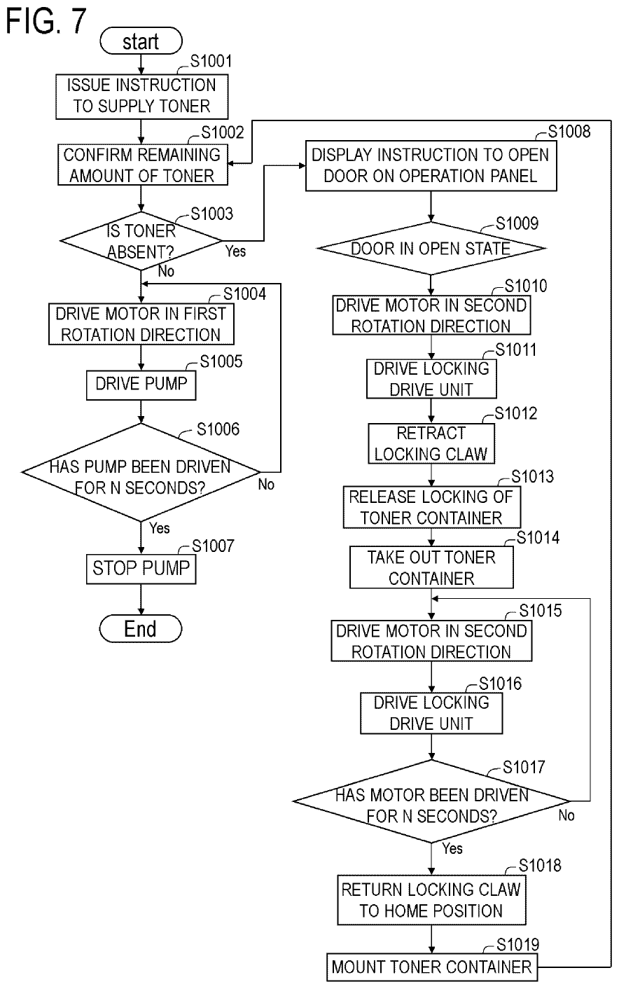

FIG. 7 is a flowchart illustrating drive control of the pump 3 and the locking claw 13 by the motor 12 in the present embodiment. When an instruction to supply the toner T from the toner container 1 to the toner accommodating portion of the developing apparatus 104 is issued (S1001), the toner remaining amount detection unit 19 confirms the remaining amount of the toner in the toner container 1 (S1002). Here, when it is detected that the toner T in the toner container 1 is not “absent”, that is, the toner T is “present” (S1003: No), the motor 12 is driven in the first rotation direction (S1004), and the pump 3 is driven to supply the air to the toner container 1 (S1005). The pump 3 is driven for a predetermined time (N seconds) (S1006), the toner Tis replenished, and the pump 3 is stopped when a predetermined time has elapsed (S1007).

When it is detected that the toner T in the toner container 1 is “absent” (S1003: Yes), the absence of the toner is reported to the user, and the user is prompted to open the toner container replacement door 2 (S1008). In a state in which the toner container replacement door 2 is opened (S1009), the motor 12 is driven in the second rotation direction opposite to the first rotation direction (S1010), the locking drive unit 15 is driven (S1011), and the locking claw 13 is moved from the position restricting position to the releasing position (S1012). When the movement of the locking claw 13 is finished, the position restriction of the empty toner container 1 is released for replacement (S1013), and the empty toner container 1 protrudes to the outside of the apparatus main body 100 and becomes replaceable (S1014). The motor 12 is driven for a predetermined time (N seconds) even after moving the locking claw 13 to the releasing position (S1015, S1016, and S1017), and is stopped at a position where the locking claw 13 is detected at the restricting position again from the releasing position, and enters a standby state (S1018). After the toner container 1 is replaced (S1019), the above-described toner replenishing operation is performed.

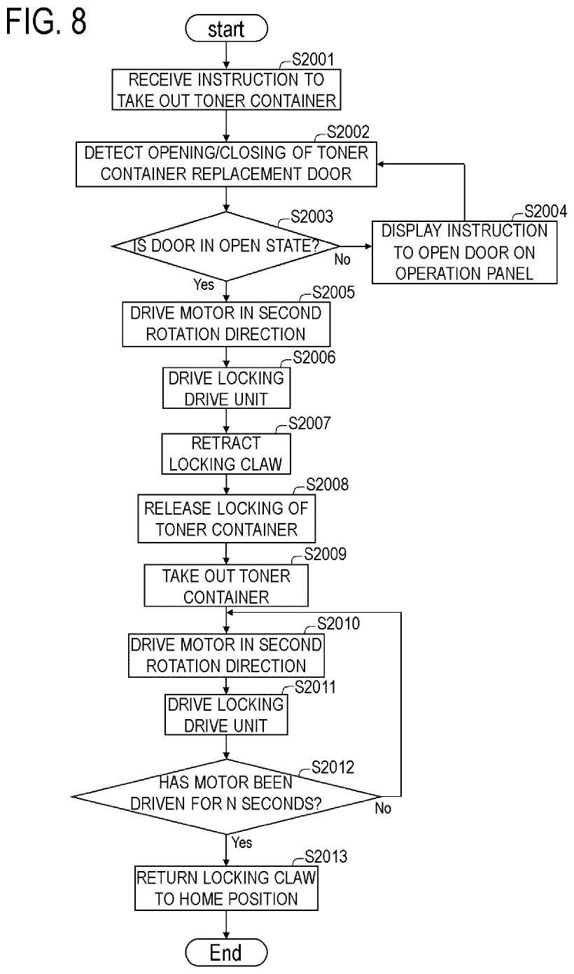

FIG. 8 is a flowchart illustrating control in a case where the user operates the operation panel 17 to take out the toner container 1 in which a sufficient amount of toner T remains. When an instruction to take out the toner container 1 is input via the operation panel 17 (S2001), a signal thereof is sent to the control portion 20, and the control portion 20 starts taking-out control of the toner container 1.

When the instruction to take out the toner container 1 is received, the control portion 20 detects the opening/closing state of the toner container replacement door 2 by the door opening/closing detection sensor 18 that detects the opening/closing state of the toner container replacement door 2 (S2002). Here, in a case where it is detected that the toner container replacement door 2 is “closed” (S2003: No), an instruction to open the toner container replacement door 2 from the user is displayed on the operation panel 17 (S2004). In a case where it is detected that the toner container replacement door 2 is “open” (S2003: Yes), the motor 12 is driven in the second rotation direction (S2005), the locking drive unit 15 is driven (S2006), and the locking claw 13 is moved from the position restricting position to the releasing position (S2007). When the movement of the locking claw 13 is finished, the position restriction of the toner container 1 is released for replacement (S2008), and the toner container 1 protrudes to the outside of the apparatus main body 100 and becomes replaceable (S2009). The motor 12 is driven for a predetermined time (N seconds) even after moving the locking claw 13 to the releasing position (S2010, S2011, and S2012), and the locking claw 13 moves to return to a home position and is stopped (S2013).

As described above, drive of a pump and drive of a locking claw are connected to the same motor, and a rotation direction of the motor is selectively used, and thus, a plurality of drives can be obtained by one drive source, so that an effect of space saving of a drive unit can be achieved, which leads to downsizing of the apparatus. The drive of the pump is independent drive for each color such that a toner of each color can be independently replenished. However, since the drive of the pump and the drive of the locking claw are coupled to the same drive source, the drive of the locking claw is also independent for each color. Therefore, the number of dedicated drive sources can be reduced and the independent drive for each color can be achieved, so that the number of components can also be reduced.

Further, as arrangement in which the pump and the locking claw are close to the same drive source is adopted, an air supply portion and a toner discharge portion, and the locking claw can be disposed close to each other. In the present embodiment, the toner conveyance connection port 9b and the air supply connection port 4b are disposed downstream of the mounting portion in the mounting direction (the direction of arrow D1), and are at positions overlapping the toner container 1 mounted on the mounting portion when viewed in the mounting direction. That is, the toner container 1 is disposed at a position included in an outer shape of the toner container 1 when viewed in the mounting direction. The toner conveyance port 8a and the air feeding port 5a are provided on a distal end surface of the toner container 1 in the mounting direction. Further, the locking claw 13 is disposed downstream of the center of the mounting portion of the toner container 1 of the apparatus main body 100 and upstream of the toner conveyance connection port 9b and the air supply connection port 4b in the mounting direction. The air supply portion and the toner discharge portion correspond to an interface portion between the image forming apparatus and the toner container, and it is necessary to perform positioning with high accuracy in order to insert tubes into the air supply portion and the toner discharge portion between the apparatuses while preventing air leakage and toner leakage. As in the present embodiment, as a locking portion is disposed close to the air supply portion and the toner discharge portion, a dimension related to the interface portion is shortened and the number of related components can be reduced, which leads to highly accurate positioning of the interface portion.

That is, according to the present embodiment, by adopting a configuration in which an air supply unit and a position restriction mechanism of a toner supply container are driven using the same drive source, it is possible to provide a downsized and simplified image forming apparatus in which a unit arrangement space and the number of components are reduced.

### Second Embodiment

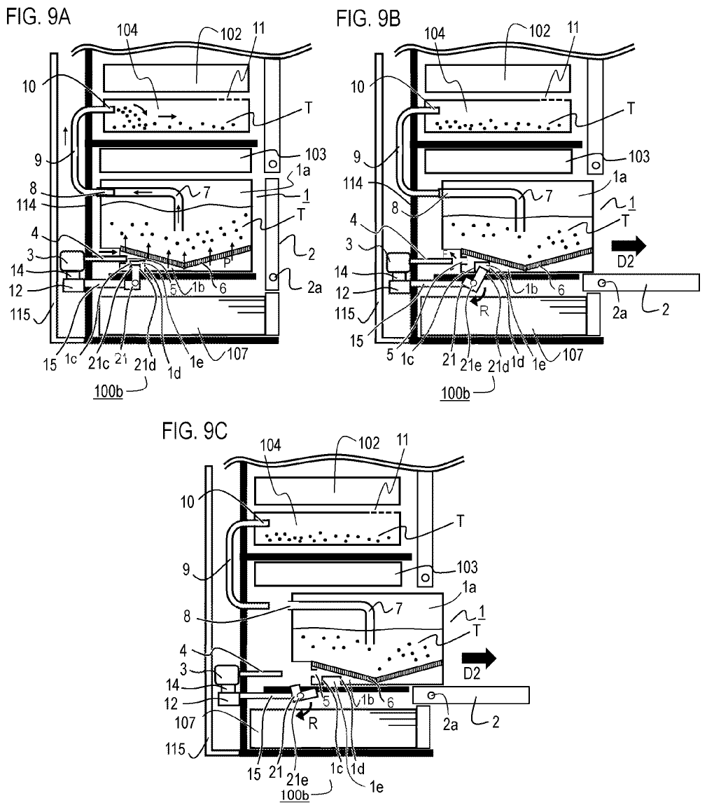

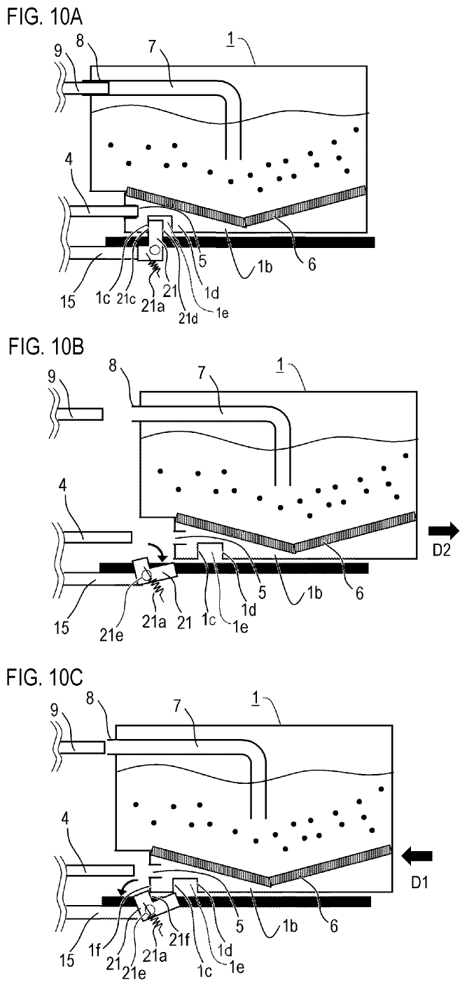

An image forming apparatus according to the second embodiment of the present disclosure will be described with reference to FIGS. 9A to 9C and FIGS. 10A to 10C. A basic configuration of an apparatus main body 100b, a toner container 1, a configuration in which a toner T is conveyed from the toner container 1 to a toner accommodating portion of a developing apparatus 104 by supply of air to the toner container 1 using a pump 3, and outlines of an air supply portion 5 and a toner discharge portion 8 in the second embodiment are the same as those in the first embodiment. Here, a configuration different from that of the first embodiment in the second embodiment will be mainly described. Matters not specifically described herein in the second embodiment are the same as those in the first embodiment.

FIGS. 9A, 9B, and 9C are cross-sectional views similar to the cross-sectional view of the apparatus main body 100 in FIG. 1 when viewed in the direction of arrow A. FIGS. 9B and 9C are views for describing a process of taking out the toner container 1 from the apparatus main body 100b in a state in which the toner container 1 is stored in an accommodating portion (mounting portion) of the apparatus main body 100b (FIG. 9A).

The pump 3 illustrated in FIG. 9A is disposed outside a frame body 114 of the apparatus main body 100b that forms a space (mounting portion) for accommodating the toner container 1 as in the first embodiment. Similarly to the pump 3, a motor 12 is disposed outside the frame body 114, and is drivingly coupled to the pump 3 via a pump drive unit 14.

Similarly to the first embodiment, in the second embodiment, when the motor 12 rotates in one direction, the pump drive unit 14 is driven to transmit drive to the pump 3, and the toner T is conveyed from the toner container 1 to the developing apparatus 104 by air. In the present embodiment, the motor 12 and the pump 3 are coupled as a set for each color, but a configuration in which the number of motors 12 is one, and a clutch that is coupled to the motor 12 and is capable of connecting and disconnecting drive transmission is connected to each of the pumps 3 of the colors may be adopted.

Position restriction of the toner container 1 will be described. A locking lever 21 is provided in the apparatus main body 100b such that the toner container 1 does not protrude after being mounted on the apparatus main body 100b. A locking receiving surface 1c with which the locking lever 21 of the apparatus main body 100b comes into contact is provided in the toner container 1. When the locking lever 21 enters a position facing the locking receiving surface 1c of the toner container 1 and comes into contact with the locking receiving surface 1c, movement of the toner container 1 in attachment/detachment directions with respect to the apparatus main body 100b is restricted, and the toner container 1 is prevented from coming off from the apparatus main body 100b. The locking lever 21 is rotatably attached to a locking drive unit 15, and the locking drive unit 15 is drivingly coupled to the motor 12. The locking lever 21 is disposed on a side close to the motor 12 to shorten a drive coupling distance to the motor 12.

FIG. 9B is a view for describing a process of taking out the toner container 1 from the apparatus main body 100b for replacement or the like. A toner container replacement door 2 is an opening/closing door (opening/closing member) that is held so as to be rotatable around a door hinge 2a, and when the toner container replacement door 2 is opened, the toner container 1 can be replaced.

The toner container 1 has, on an outer bottom surface (lower surface) of a bottom portion, a recessed portion 1e that is recessed in a direction (vertical direction) intersecting the attachment/detachment directions of the toner container 1 with respect to the apparatus main body 100b as a restricted portion. The recessed portion 1e has the locking receiving surface 1c serving as an engaged surface (engaged portion) and a locking pushing-out surface 1d serving as a pressed surface (pressed portion). The locking receiving surface 1c is a surface facing a detachment direction (second direction) opposite to an attachment direction (first direction) of the toner container 1 with respect to the apparatus main body 100b, and the locking pushing-out surface 1d is a surface facing the attachment direction. The locking receiving surface 1c and the locking pushing-out surface 1d face each other in the attachment/detachment directions of the toner container 1 with respect to the apparatus main body 100b. The locking lever 21 serving as a restricting member has a restricting surface 21c (engagement portion) oriented in the mounting direction so as to face the locking receiving surface 1c and a pressing surface 21d (pressing portion) oriented in the detachment direction so as to face the locking pushing-out surface 1d in a restricting posture (restricting position). That is, the locking lever 21 is the restricting member and integrally includes the pressing portion that presses the toner container 1 in the detachment direction. The locking lever 21 is provided in the apparatus main body 100b so as to be rotatable around a rotation axis of a rotation shaft 21e in a direction intersecting (orthogonal to) both the attachment/detachment directions and the vertical direction. The locking lever 21 rotates around the rotation shaft 21e by an action of the locking drive unit 15 that has received a rotational driving force of the motor 12. By such rotation, the locking lever 21 can be changed from the restricting posture (restricting position) to a retracted posture (non-restricting posture, non-restricting position, allowing position, or retracted position) in which a segment having the restricting surface 21c and the pressing surface 21d comes out of the recessed portion 1e. In a process of such a posture change, the pressing surface 21d of the locking lever 21 presses the locking pushing-out surface 1d of the toner container 1 in the detachment direction. As a result, the toner container 1 moves in the detachment direction from an attachment completion position in the mounting portion of the apparatus main body 100b, and at least a part of the toner container 1 is exposed to the outside of the apparatus main body 100b.

In a case where the toner container 1 needs to be replaced, the motor 12 rotates in a direction (second rotation direction) opposite to a direction (first rotation direction) in which the pump 3 is driven, and drives the locking drive unit 15. By the locking drive unit 15, the locking lever 21 rotates in a direction of arrow R (clockwise in the figure) and is retracted from a position facing the locking receiving surface 1c of the toner container 1. At this time, the pump 3 is not driven (a driving force is not transmitted from the motor 12) and is stopped as in the first embodiment. When the locking lever 21 is retracted, the position restriction of the toner container 1 in a protruding direction from the apparatus main body 100b is released. The locking lever 21 is configured to push the locking pushing-out surface 1d of the toner container 1 when the rotation is continued as it is. As a result, the toner container 1 is pushed out to the outside of the apparatus main body 100b, moves in the direction of the arrow while being supported by an upper surface of the opened toner container replacement door 2, and can be taken out.

FIGS. 10A, 10B, and 10C are views illustrating a relationship between the operation of the locking lever 21 and the movement of the toner container 1. As illustrated in FIG. 10A, the locking lever 21 is rotatably coupled to the locking drive unit 15, and a spring 21a serving as an elastic member (urging member) capable of applying a predetermined urging force to the toner container 1 is attached to the locking lever 21.

When replacing the toner container 1, the locking lever 21 rotates in an arrow direction (clockwise in the figure) to be retracted from the locking receiving surface 1c of the toner container 1 as illustrated in FIG. 10B, and the position restriction of the toner container 1 is released. The locking lever 21 that has rotated to a position restriction releasing position is held at the restriction releasing position by the spring 21a.

At the time of insertion of the toner container 1, the locking lever 21 is stopped at the restriction releasing position as illustrated in FIG. 10C. The locking lever 21 moves by drive in a releasing direction (clockwise in the figure), and in a restricting direction, the drive idles by a one-way gear (not illustrated) provided in the locking drive unit 15, and the locking lever 21 can move without the drive. When the toner container 1 is inserted into the mounting portion of the apparatus main body 100b again, the toner container 1 pushes down the locking lever 21, and the toner container 1 moves over the locking lever 21 to a mounting position. The toner container 1 has an action surface (action portion) 1f facing the attachment direction (a direction of arrow D1), and the action surface 1f comes into contact with an action receiving surface (action receiving portion) 21f provided on the locking lever 21 to apply a force for rotating the locking lever 21 in the restricting direction (counterclockwise in the figure). When the locking lever 21 rotates in the restricting direction beyond a predetermined rotation amount (rotation phase) by the contact of the action surface 1f, an action mode of an elastic force (urging force) of the spring 21a on the locking lever 21 is changed, and the locking lever 21 is changed from the retracted posture to the restricting posture by the elastic force of the spring 21a. The spring 21a is provided so as to have a relationship of a spring hook and a fulcrum to form a so-called toggle mechanism. That is, the spring 21a is configured to urge the locking lever 21 to maintain the restricting posture in a state in which the toner container 1 is mounted, and urge the locking lever 21 to maintain the releasing posture in a state in which the toner container 1 is removed. Therefore, when the locking lever 21 returns to the restricting position by the spring 21a, the locking lever 21 comes into contact with the locking receiving surface 1c of the toner container 1 to perform the position restriction.

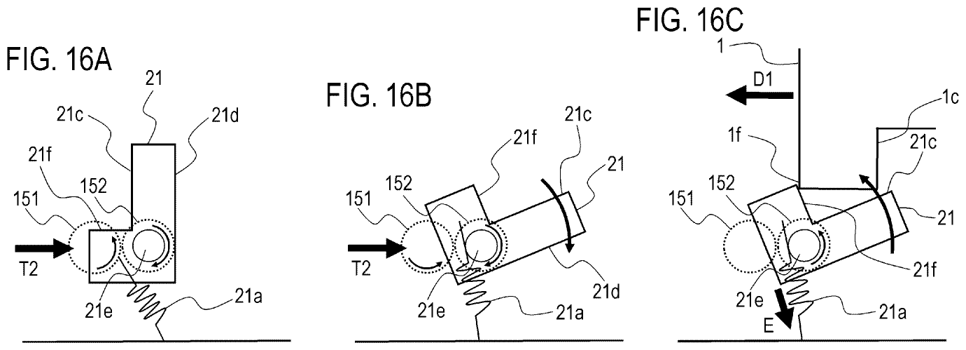

A drive coupling configuration of the locking lever 21 and the locking drive unit 15 will be described in more detail with reference to FIGS. 16A to 16C. FIG. 16A is a schematic explanatory view of the drive coupling configuration of the locking lever 21 and the locking drive unit 15, and illustrates a state in which the locking lever 21 is at the restricting position. The locking drive unit 15 includes, as a part of a drive train, a first gear 151 and a second gear 152 disposed downstream of the drive train of the first gear 151 and disposed coaxially with the locking lever 21. A driving force T2 generated by the rotation of the motor 12 in the second rotation direction is sequentially transmitted in the drive train of the locking drive unit 15, and rotates the locking lever 21 around the rotation axis of the rotation shaft 21e via rotation of the first gear 151 and the second gear 152. The second gear 152 is a one-way gear, and is configured to idle with respect to the first gear 151 that rotates by a driving force generated by the rotation of the motor 12 in the first rotation direction.

FIG. 16B is a schematic explanatory view of the drive coupling configuration of the locking lever 21 and the locking drive unit 15, and illustrates a process in which the locking lever 21 is changed (rotates) from the restricting posture to the retracted posture by the driving force T2 transmitted from the locking drive unit 15. The locking lever 21 is integrally coupled to the second gear 152 which is a one-way gear, and is changed from the restricting posture to the retracted posture by the rotation of the second gear 152 against an urging force of the spring 21a that urges the locking lever 21 to be positioned at the restricting position.

FIG. 16C is a schematic explanatory view of the drive coupling configuration of the locking lever 21 and the locking drive unit 15, and illustrates a process in which the locking lever 21 is changed from the retracted posture to the restricting posture by a force received from the toner container 1 inserted into the mounting portion of the apparatus main body 100b (moving in the direction of arrow D1). As described above, the action surface 1f of the toner container 1 comes into contact with the action receiving surface 21f of the locking lever 21 to apply the force for rotating the locking lever 21 in the restricting direction (counterclockwise in the figure). At this time, the second gear 152 rotates in a direction opposite to the rotation direction by the driving force T2, that is, the second gear 152 rotates in the first rotation direction, and the second gear 152, which is a one-way gear, idles with respect to the first gear 151. As a result, the locking lever 21 can rotate independently of the drive coupling of the locking drive unit 15, and as an action of an urging force (elastic contracting force) E of the spring 21a is also applied, the locking lever 21 rotates so as to return from the retracted posture to the restricting posture.

Since control when replacing the toner container 1 is the same as that in the first embodiment (FIGS. 7 and 8), the description thereof is omitted here.

Similarly to the first embodiment, in the second embodiment, drive of a pump and drive of a locking lever are connected to the same motor, and a rotation direction of the motor is selectively used, and thus, a plurality of drives can be obtained by one drive source. Therefore, an effect of space saving of a drive unit can be achieved, which leads to downsizing of the apparatus. The drive of the pump is independent drive for each color such that a toner of each color can be independently replenished. However, since the drive of the pump and the drive of the locking lever are coupled to the same drive source, the drive of the locking lever is also independent for each color. Therefore, the number of dedicated drive sources can be reduced and the independent drive for each color can be achieved, so that the number of components can also be reduced.

In addition, by using the same drive source, arrangement in which the pump and the locking lever are close to each other can be adopted, and thus, an air supply portion and a toner discharge portion, and the locking lever can be disposed close to each other. The air supply portion and the toner discharge portion correspond to an interface portion between the image forming apparatus and the toner container, and it is necessary to perform positioning with high accuracy in order to insert tubes into the air supply portion and the toner discharge portion between the apparatuses while preventing air leakage and toner leakage. As in the present embodiment, as a locking portion is disposed close to the air supply portion and the toner discharge portion, a dimension related to the interface portion is shortened and the number of related components can be reduced, which leads to highly accurate positioning of the interface portion.

### Third Embodiment

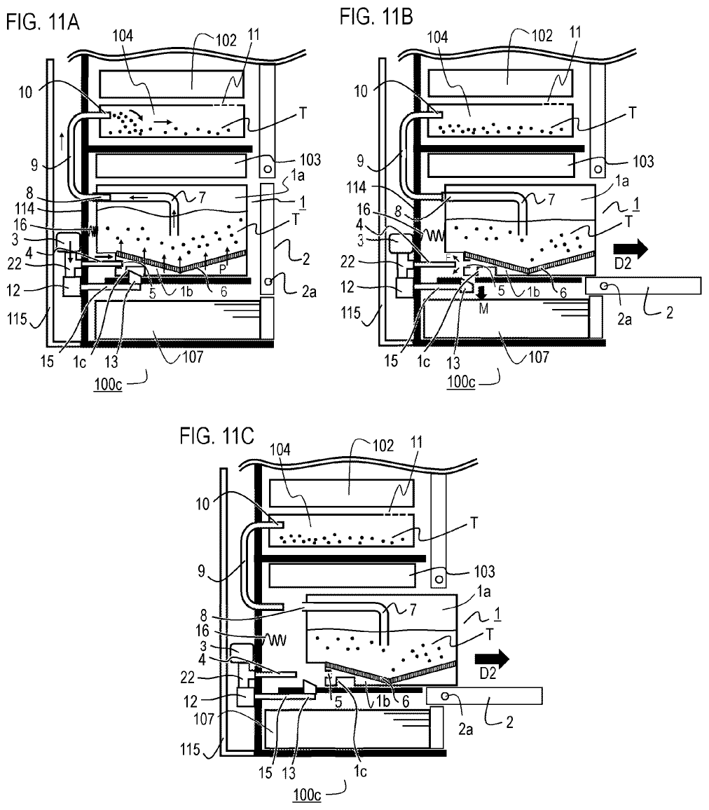

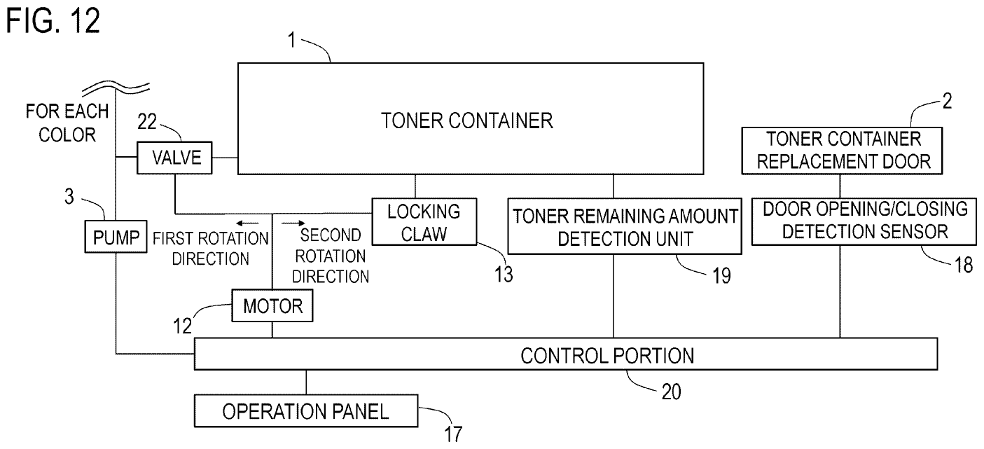

An image forming apparatus according to a third embodiment of the present disclosure will be described with reference to FIGS. 11A to 11C and FIG. 12. In the third embodiment, a basic configuration of an apparatus main body 100c, a toner container 1, and an outline of a configuration in which a toner Tis conveyed from the toner container 1 to a toner accommodating portion of a developing apparatus 104 by supply of air to the toner container 1 using a pump 3 are the same as those in the first embodiment. Here, a configuration different from those of the first and second embodiments in the third embodiment will be mainly described. Matters not specifically described herein in the third embodiment are the same as those in the first and second embodiments.

FIGS. 11A, 11B, and 11C are cross-sectional views similar to the cross-sectional view of the apparatus main body 100 in FIG. 1 when viewed in the direction of arrow A. FIGS. 11B and 11C are views for describing a process of taking out the toner container 1 from the apparatus main body 100c in a state in which the toner container 1 is stored in an accommodating portion (mounting portion) of the apparatus main body 100c (FIG. 11A).

The pump 3 illustrated in FIG. 11A is disposed outside a frame body 114 of the apparatus main body 100c that forms a space (mounting portion) for accommodating the toner container 1 as in the first embodiment. In the present embodiment, only one pump 3 is provided in the apparatus main body 100c instead of being provided for each toner container. An air supply portion 5 of the toner container 1 of each color includes a valve 22, and the valve 22 of each color is connected to the single pump 3. Similarly to the pump 3, a motor 12 is disposed outside the frame body 114 and drivingly coupled to the valve 22. In the present embodiment, the motor 12 and the valve 22 are coupled as a set for each color, but a configuration in which the number of motors 12 is one, and a clutch that is coupled to the motor 12 and is capable of connecting and disconnecting drive transmission is connected to each of the valves 22 of the colors may be adopted.

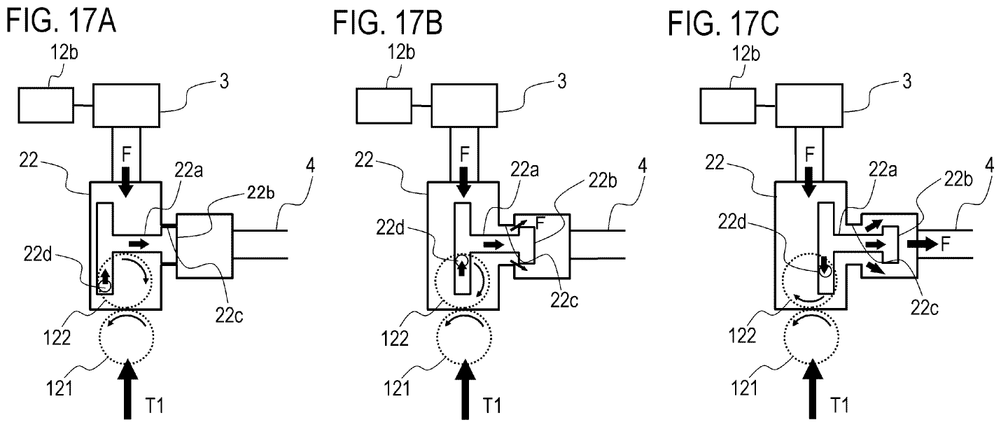

In a toner replenishing operation according to the third embodiment, unlike the first embodiment, when the motor 12 rotates in one direction, the valve 22 is opened to feed air fed from the pump 3 to the toner container 1, and the toner T is conveyed from the toner container 1 to the developing apparatus 104 by a pressure P of the air. In the third embodiment, the pump 3 is driven by a drive source (a motor 12b in FIG. 17A) different from the motor 12.

Position restriction of the toner container 1 will be described. A locking claw 13 is provided in the apparatus main body 100c such that the toner container 1 does not protrude after being mounted on the apparatus main body 100c. A locking receiving surface 1c with which the locking claw 13 of the apparatus main body 100c comes into contact is provided in the toner container 1. When the locking claw 13 enters a position facing the locking receiving surface 1c of the toner container 1 and comes into contact with the locking receiving surface 1c, movement of the toner container 1 in attachment/detachment directions with respect to the apparatus main body 100c is restricted, and the toner container 1 is prevented from coming off from the apparatus main body 100c. The locking claw 13 is movably attached to a locking drive unit 15, and the locking drive unit 15 is drivingly coupled to the motor 12. The locking claw 13 is disposed on a side close to the motor 12 to shorten a drive coupling distance to the motor 12.

FIG. 11B is a view for describing a process of taking out the toner container 1 from the apparatus main body 100c for replacement or the like. A toner container replacement door 2 is an opening/closing door (opening/closing member) that is held so as to be rotatable around a door hinge 2a, and when the toner container replacement door 2 is opened, the toner container 1 can be replaced.

In a case where the toner container 1 needs to be replaced, the motor 12 rotates in a direction (second rotation direction) opposite to a direction (first rotation direction) in which the valve 22 is driven, the valve 22 is closed, and the locking drive unit 15 is driven. By the locking drive unit 15, the locking claw 13 moves in a direction of arrow M, that is, in a direction intersecting the attachment/detachment directions (D1 and D2) of the toner container 1 with respect to the apparatus main body 100c, and is retracted from a position facing the locking receiving surface 1c of the toner container 1.

When the motor 12 drives the locking drive unit 15, the valve 22 is not driven (a driving force is not transmitted from the motor 12) and is stopped. The reason is that a one-way gear (not illustrated) is provided in the valve 22 as in the first embodiment, and an action thereof is exerted.

When the locking claw 13 is retracted, the position restriction of the toner container 1 in a protruding direction from the apparatus main body 100c is released, and the toner container 1 can be taken out from the apparatus main body 100c. When the position restriction of the toner container 1 is released, the toner container 1 is pushed out from the mounting portion of the apparatus main body 100c to a position where at least a part of the toner container 1 is exposed to the outside by a pressing member 16. The toner container 1 moves in the direction of the arrow while being supported by an upper surface of the opened toner container replacement door 2, and can be taken out.

A configuration of the valve 22 and a drive coupling configuration of the valve 22 and the motor 12 will be described in more detail with reference to FIGS. 17A to 17C. FIG. 17A is a schematic explanatory view of the configuration of the valve 22 and the drive coupling configuration of the valve 22 and the motor 12, and illustrates a state in which a valve body 22a of the valve 22 is seated on a valve seat 22b and the valve 22 is closed. Between the motor 12 and the valve 22, as a part of a drive train, a first gear 121 and a second gear 122 disposed downstream of the drive train of the first gear 121 and coupled to the valve body 22a such that a coupling position with respect to the valve body 22a can be changed are provided. The second gear 122 includes a coupling shaft 22d at a position away from a rotation center, and the coupling shaft 22d is coupled to the valve body 22a so as to be able to reciprocally change the coupling position in a direction intersecting a movement direction of the valve body 22a.

FIG. 17B is a schematic explanatory view of the configuration of the valve 22 and the drive coupling configuration of the valve 22 and the motor 12, and illustrates a state in which the valve body 22a is separated from the valve seat 22b in the valve 22 and the valve 22 is changed from a closed state to an open state. A driving force T1 generated by the rotation of the motor 12 in the first rotation direction is sequentially transmitted in the drive train between the motor 12 and the valve 22 to sequentially rotate the first gear 121 and the second gear 122. The rotation of the second gear 122 changes the position of the coupling shaft 22d, and the position change of the coupling shaft 22d applies a force to the valve body 22a to move the valve body 22a in an opening/closing direction with respect to the valve seat 22b. As a result, the valve 22 is opened, and the air supplied from the pump 3 can flow to an air conveyance passage 4. FIG. 17C is a schematic explanatory view of the configuration of the valve 22 and the drive coupling configuration of the valve 22 and the motor 12, and illustrates a state in which the valve 22 is further opened in the state illustrated in FIG. 17B. The valve body 22a is configured to repeat opening and closing movement (reciprocating movement) with respect to the valve seat 22b by continuation of the rotation of the second gear 122 (continuation of the transmission of the driving force T1). In addition, the second gear 122 is a one-way gear, and is configured to idle with respect to the first gear 121 that rotates by a driving force generated by the rotation of the motor 12 in the second rotation direction.

Since the position restriction when mounting the toner container 1 is the same as that in the first embodiment, the description thereof is omitted here.

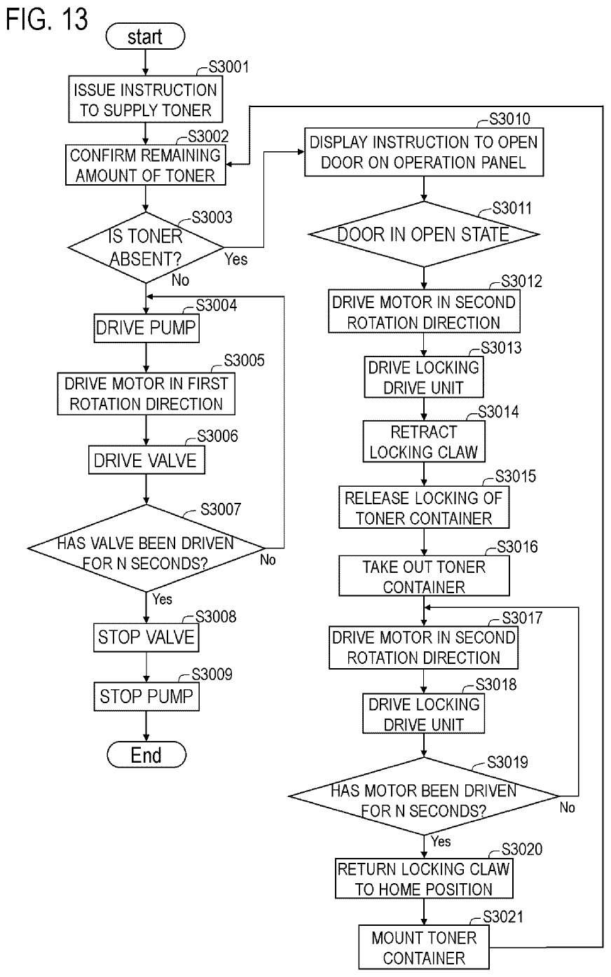

FIG. 12 is a block diagram illustrating a configuration of a control system of a toner supply portion in the third embodiment. FIG. 13 is a flowchart illustrating drive control of the valve 22 and the locking claw 13 by the motor 12. In the drive control according to the third embodiment, the control (S1005 and S1007) of the pump 3 in the first embodiment is replaced with control (S3006 and S3008) of the valve 22. The drive control according to the third embodiment is different from the drive control according to the first embodiment in that pump control (S3004 and S3009) is added independently of the control of the motor 12. Since other control and the like of the motor 12 are the same as those in the first embodiment, the description thereof is omitted here.

Similarly to the first embodiment, in the third embodiment, drive of a valve and drive of a locking claw are connected to the same motor, and a rotation direction of the motor is selectively used, and thus, a plurality of drives can be obtained by one drive source. Therefore, an effect of space saving of a drive unit can be achieved, which leads to downsizing of the apparatus. The drive of the valve is independent drive for each color such that a toner of each color can be independently replenished. However, since the drive of the valve and the drive of the locking claw are coupled to the same drive source, the drive of the locking claw is also independent for each color. Therefore, the number of dedicated drive sources can be reduced and the independent drive for each color can be achieved, so that the number of components can also be reduced.

In addition, by using the same drive source, arrangement in which the valve and the locking claw are close to each other can be adopted, and thus, an air supply portion and a toner discharge portion, and the locking claw can be disposed close to each other. The air supply portion and the toner discharge portion correspond to an interface portion between the image forming apparatus and the toner container, and it is necessary to perform positioning with high accuracy in order to insert tubes into the air supply portion and the toner discharge portion between the apparatuses while preventing air leakage and toner leakage. As in the present embodiment, as a locking portion is disposed close to the air supply portion and the toner discharge portion, a dimension related to the interface portion is shortened and the number of related components can be reduced, which leads to highly accurate positioning of the interface portion. In addition, since a single pump is provided in each toner container, effects such as cost reduction and downsizing can be obtained.

### Fourth Embodiment

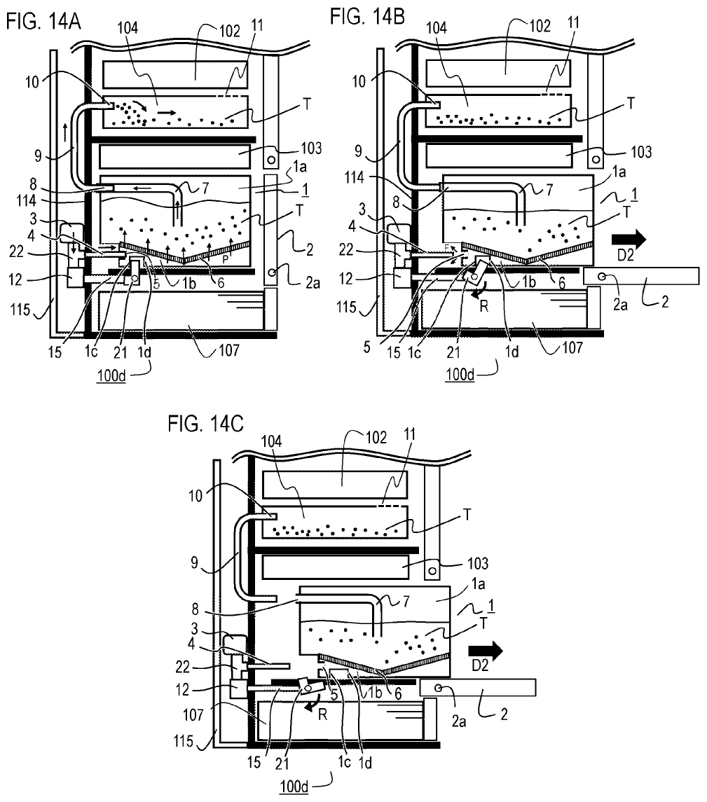

An image forming apparatus according to a fourth embodiment of the present disclosure will be described with reference to FIGS. 14A to 14C. In the fourth embodiment, a basic configuration of an apparatus main body 100d, a toner container 1, and an outline of a configuration in which a toner Tis conveyed from the toner container 1 to a toner accommodating portion of a developing apparatus 104 by supply of air to the toner container 1 using a pump 3 are the same as those in the first embodiment. Further, control related to a toner replenishing operation and a replacement operation for the toner container 1 in the fourth embodiment is the same as that in the third embodiment. Here, a configuration different from those of the first to third embodiments in the fourth embodiment will be mainly described. Matters not specifically described herein in the fourth embodiment are the same as those in the first to third embodiments.

FIGS. 14A, 14B, and 14C are cross-sectional views similar to the cross-sectional view of the apparatus main body 100 in FIG. 1 when viewed in the direction of arrow A. FIGS. 14B and 14C are views for describing a process of taking out the toner container 1 from the apparatus main body 100d in a state in which the toner container 1 is stored in an accommodating portion (mounting portion) of the apparatus main body 100d (FIG. 14A).

The pump 3 illustrated in FIG. 14A is disposed outside a frame body 114 of the apparatus main body 100d that forms a space (mounting portion) for accommodating the toner container 1 as in the first embodiment. Similarly to the third embodiment, one pump 3 is provided in the apparatus main body 100d. Similarly to the third embodiment, an air supply portion 5 of the toner container 1 of each color includes a valve 22, and the valve 22 of each color is connected to the single pump 3. Similarly to the pump 3, a motor 12 is disposed outside the frame body 114 and drivingly coupled to the valve 22. In the present embodiment, the motor 12 and the valve 22 are coupled as a set for each color, but a configuration in which the number of motors 12 is one, and a clutch that is coupled to the motor 12 and is capable of connecting and disconnecting drive transmission is connected to each of the valves 22 of the colors may be adopted.

Similarly to the third embodiment, when the motor 12 rotates in one direction, the valve 22 is driven to be opened, so that air fed from the pump 3 is fed to the toner container 1, and the toner T is conveyed from the toner container 1 to the developing apparatus 104 by a pressure P of the air.

Next, position restriction of the toner container 1 will be described. A locking lever 21 is provided in the apparatus main body 100d such that the toner container 1 does not protrude after being mounted on the apparatus main body 100d. A locking receiving surface 1c with which the locking lever 21 of the apparatus main body 100d comes into contact is provided in the toner container 1. When the locking lever 21 enters a position facing the locking receiving surface 1c of the toner container 1 and comes into contact with the locking receiving surface 1c, movement of the toner container 1 in attachment/detachment directions with respect to the apparatus main body 100d is restricted, and the toner container 1 is prevented from coming off from the apparatus main body 100d. The locking lever 21 is rotatably attached to a locking drive unit 15, and the locking drive unit 15 is drivingly coupled to the motor 12. The locking lever 21 is disposed on a side close to the motor 12 to shorten a drive coupling distance to the motor 12.

FIG. 14B is a view for describing a process of taking out the toner container 1 from the apparatus main body 100d for replacement or the like. A toner container replacement door 2 is an opening/closing door (opening/closing member) that is held so as to be rotatable around a door hinge 2a, and when the toner container replacement door 2 is opened, the toner container 1 can be replaced.

In a case where the toner container 1 needs to be replaced, the motor 12 rotates in a direction (second rotation direction) opposite to a direction (first rotation direction) in which the valve 22 is driven, and drives the locking drive unit 15. By the locking drive unit 15, the locking lever 21 rotates in a direction of arrow R and is retracted from a position facing the locking receiving surface 1c of the toner container 1. At this time, the valve 22 is not driven (a driving force is not transmitted from the motor 12) and is stopped as in the third embodiment. When the locking lever 21 is retracted, the position restriction of the toner container 1 in a protruding direction from the apparatus main body 100d is released. The locking lever 21 is configured to push the locking pushing-out surface 1d of the toner container 1 when the rotation is continued as it is. As a result, the toner container 1 is pushed out to the outside of the apparatus main body 100d, moves in the direction of the arrow while being supported by an upper surface of the opened toner container replacement door 2, and can be taken out. Since the position restriction when mounting the toner container 1 is the same as that in the second embodiment, the description thereof is omitted here.

Similarly to the first embodiment, in the fourth embodiment, drive of a valve and drive of a locking lever are connected to the same motor, and a rotation direction of the motor is selectively used, and thus, a plurality of drives can be obtained by one drive source. Therefore, an effect of space saving of a drive unit can be achieved, which leads to downsizing of the apparatus. The drive of the valve is independent drive for each color such that a toner of each color can be independently replenished. However, since the drive of the valve and the drive of the locking lever are coupled to the same drive source, the drive of the locking lever is also independent for each color. Therefore, the number of dedicated drive sources can be reduced and the independent drive for each color can be achieved, so that the number of components can also be reduced.

In addition, by using the same drive source, arrangement in which the valve and the locking lever are close to each other can be adopted, and thus, an air supply portion and a toner discharge portion, and the locking lever can be disposed close to each other. The air supply portion and the toner discharge portion correspond to an interface portion between the image forming apparatus and the toner container, and it is necessary to perform positioning with high accuracy in order to insert tubes into the air supply portion and the toner discharge portion between the apparatuses while preventing air leakage and toner leakage. As in the present embodiment, as a locking portion is disposed close to the air supply portion and the toner discharge portion, a dimension related to the interface portion is shortened and the number of related components can be reduced, which leads to highly accurate positioning of the interface portion. In addition, since a single pump is provided in each toner container, effects such as cost reduction and downsizing can be obtained.

The configurations of the respective embodiments described above can be combined with each other as much as possible.

According to the present disclosure, it is possible to achieve downsizing and cost reduction of an image forming apparatus in which a developer is replenished from a developer container detachably attached to an apparatus main body.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-104492, filed on Jun. 27, 2024, which is hereby incorporated by reference herein in its entirety.

What is claimed is:

1. An image forming apparatus forming an image on a recording material, the image forming apparatus comprising:
an apparatus main body that includes a body accommodating portion that accommodates developer, and a mounting portion; and
a developer container that is mounted by being moved in a mounting direction relative to the mounting portion of the apparatus main body, and is detached by being moved in a detachment direction opposite to the mounting direction, wherein
the developer container includes:
a developer accommodating chamber that accommodates the developer and is provided with a discharge port;
a filter that allows passage of air and suppresses passage of the developer;
an air chamber that is partitioned from the developer accommodating chamber by the filter and is provided with an air receiving port for receiving the air; and
an engaged portion, and
the apparatus main body includes:
a developer conveyance passage that is configured to communicate with an inside of the body accommodating portion and is provided with a developer receiving port, the developer conveyance passage allowing communication between the developer accommodating chamber of the developer container and the inside of the body accommodating portion by connecting the developer receiving port to the discharge port of the developer container mounted at a predetermined position in the mounting portion;
an air supply passage that is provided with an air feeding port, the air supply passage being configured to communicate with the air chamber of the developer container by connecting the air feeding port to the air receiving port of the developer container mounted at the predetermined position in the mounting portion;
an air supply portion that supplies the air from the air receiving port of the developer container to the air chamber via the air supply passage;
a restricting member having an engagement portion, the restricting member being movable between a restricting position and an allowing position, the restricting position being a position where the engagement portion is engaged with the engaged portion of the developer container so as to restrict the developer container from moving in the detachment direction from the predetermined position in the mounting portion, and the allowing position being a position where the engagement portion is not engaged with the engaged portion so as to allow the developer container to move in the detachment direction from the predetermined position;
a movement mechanism that moves the restricting member between the restricting position and the allowing position;
a drive transmission mechanism that includes a motor and a drive transmission portion, the drive transmission portion being configured to switch between a first state and a second state, the first state being a state in which a driving force of the motor is transmitted to the air supply portion and is not transmitted to the movement mechanism, and the second state being a state in which the driving force of the motor is transmitted to the movement mechanism and is not transmitted to the air supply portion; and
a control portion that controls the drive transmission mechanism.

2. The image forming apparatus according to claim 1,
wherein the motor is rotatable in a first rotation direction and a second rotation direction opposite to the first rotation direction,
wherein the drive transmission portion is configured to cause the driving force of the motor to enter the first state in a case where the motor rotates in the first rotation direction and to enter the second state in a case where the motor rotates in the second rotation direction, and
wherein the control portion controls a rotation direction of the motor.

3. The image forming apparatus according to claim 1, wherein
the developer receiving port and the air feeding port are disposed downstream of the mounting portion in the mounting direction, and are at positions overlapping the developer container mounted at the predetermined position in the mounting portion in a case of being viewed in the mounting direction.

4. The image forming apparatus according to claim 3, wherein
the discharge port and the air receiving port are provided on an end surface of the developer container in the mounting direction.

5. The image forming apparatus according to claim 1, wherein
the engaged portion is disposed downstream of a center of the developer container and upstream of the developer receiving port and the air feeding port in the mounting direction.

6. The image forming apparatus according to claim 1,
wherein the developer conveyance passage is configured such that the developer receiving port is inserted into the discharge port in the detachment direction,
wherein the developer container includes a first sealing member that is in close contact with an outer periphery of the developer conveyance passage on an inner periphery of the discharge port,
wherein the air supply passage is configured such that the air feeding port is inserted into the air receiving port in the detachment direction,
wherein the developer container includes a second sealing member that is in close contact with an outer periphery of the air supply passage on an inner periphery of the air receiving port, and
wherein a first timing at which the first sealing member no longer remains in close contact with the outer periphery of the developer conveyance passage in a case of moving the developer container from the mounting portion in the detachment direction is later than a second timing at which the second sealing member no longer remains in close contact with the outer periphery of the air supply passage.

7. The image forming apparatus according to claim 1, wherein
the air supply portion includes a pump driven by the driving force of the motor.

8. The image forming apparatus according to claim 1, wherein
the air supply portion includes a pump and a valve that is opened and closed by the driving force of the motor.

9. The image forming apparatus according to claim 1, wherein
the apparatus main body includes a pressing portion that presses, in the detachment direction, the developer container mounted at the predetermined position in the mounting portion.

10. The image forming apparatus according to claim 9, wherein
the pressing portion includes an elastic member that is configured to apply an urging force acting in the detachment direction on the developer container mounted at the predetermined position in the mounting portion.

11. The image forming apparatus according to claim 10, wherein
the developer container includes:
an engaged surface that faces the engagement portion of the restricting member at the restricting position in the detachment direction; and
a pressed surface that faces the pressing portion in the mounting direction,
wherein the restricting member is provided inside the mounting portion so as to be rotatable around a rotation axis intersecting the mounting direction,
wherein the pressing portion is provided integrally with the restricting member, and
wherein the pressing portion faces the pressed surface after the restricting member rotates to a rotation phase to reach the allowable position, and is configured to press the pressed surface in the detachment direction by the rotation of the restricting member.

12. The image forming apparatus according to claim 1, wherein
the restricting member is provided so as to be movable in a direction intersecting the mounting direction inside the mounting portion.

13. The image forming apparatus according to claim 1, wherein
the air chamber is positioned below the developer accommodating chamber.
